(19) United States
(12) Patent Application Publication
(10) Pub. No.: US 2016/0248986 A1
(43) Pub. Date: Aug. 25, 2016

(54) DIGITAL CAMERAS HAVING REDUCED STARTUP TIME, AND RELATED DEVICES, METHODS, AND COMPUTER PROGRAM PRODUCTS

(71) Applicant: SONY CORPORATION, Tokyo (JP)

(72) Inventors: Fredrik Mattisson, Lund (SE); Daniel Linaker, Lund (SE)

(21) Appl. No.: 14/378,905

(22) PCT Filed: Feb. 27, 2014
(86) PCT No.: PCT/JP2014/001051

§ 371 Date: Aug. 14, 2014

(51) Int. Cl. H04N 5/243; G06T 5/40; H04N 9/73; H04N 5/232; H04N 5/225

(52) U.S. Cl. CPC H04N 5/243; H04N 5/23212; H04N 5/2258; H04N 9/735; G06T 5/40

(57) ABSTRACT

A method of setting an auto exposure level at startup for a digital array camera having a plurality of image sensors includes acquiring a first frame of image data from the plurality of image sensors via an image signal processor. The image signal processor generates a respective histogram for the image data from each respective image sensor. The histogram having the best exposure level is selected and the exposure level for each image sensor is then set to the exposure level for the selected histogram prior to acquiring a next frame of image data from the image sensors. A control algorithm, such as a 3A algorithm, may be used to select a histogram having the best exposure level and to set an exposure level for each image sensor to the exposure level for the selected histogram.

### FIELD OF THE INVENTION

The present application relates generally to digital cameras and, more particularly, to adjusting auto exposure of digital cameras.

### BACKGROUND

The startup time for a digital camera may be important to users. For example, when a user wants to capture an image with a digital camera, the amount of time he/she has to wait for the camera to be ready to acquire the image may negatively impact user experience. A major part of the startup time for a digital camera system is the time needed for auto exposure convergence. Auto exposure convergence is the process by which an algorithm associated with an image signal processor attempts to adjust the auto exposure average of an image being captured to an acceptable brightness range. Typically, the first six to eight (6-8) frames of image data when a digital camera is turned on are discarded because of the time required for convergence.

FIG. 1 is a block diagram illustrating an image sensor exposure loop in a conventional digital camera. When the camera is turned on by a user, the ambient light level is unknown. An exposure to use for the first frame of image data is estimated, and this first frame of image data is transmitted to the image signal processor (ISP). The ISP generates exposure data in the form of histograms which are used by the 3A algorithms (auto exposure, auto white balance, and auto focus) to adjust the exposure on the sensor for the next frame. This is repeated for a number of frames until a proper exposure level is obtained and the image frames can then be displayed on the camera display. Unfortunately, the more frames of image data that are required, the longer it takes for a digital camera to be ready for use, which may lead to user dissatisfaction.

### SUMMARY

According to some embodiments of the present invention, a method of setting an auto exposure level at startup for a digital camera having a plurality of image sensors includes acquiring a first frame of image data from the plurality of image sensors via an image signal processor. At startup, each sensor may be set up with a respective unique or different exposure level for the first frame. The image signal process generates a respective histogram for the image data from each respective image sensor. The histogram having the best exposure level for the image is selected and the exposure level for each image sensor is then set to the exposure level for the selected histogram prior to acquiring a next frame of image data from the image sensors. A control algorithm, such as a 3A (auto exposure, auto white balance, and auto focus) algorithm, may be used by the image signal processor to select a histogram having the best exposure level and to set an exposure level for each image sensor to the exposure level for the selected histogram.

In some embodiments, the plurality of image sensors are arranged in an array. For example, the plurality of image sensors may include an array of red, green, and blue image sensors. An exemplary array of red, green, and blue image sensors may include four red image sensors, eight green image sensors, and four blue image sensors.

In some embodiments, acquiring a frame of image data from the plurality of image sensors may include acquiring a frame of image data only from the green image sensors.

According to other embodiments of the present invention, an electronic device, such as a mobile cellular telephone, a portable media player, a tablet computer, a camera, etc., includes a digital camera having a plurality of image sensors, an image signal processor, and a memory coupled to the image sensor processor. The memory includes computer readable program code embodied in the memory that, when executed by the image signal processor, causes the image signal processor to acquire a first frame of image data from the plurality of image sensors, generate a plurality of histograms, wherein each histogram is representative of pixel luminance values for image data from a respective image sensor, select one of the histograms having the best exposure level for the image, and set an exposure level for each image sensor to the exposure level for the selected histogram prior to acquiring a next frame of image data from the image sensors. The image signal processor may use a control algorithm, such as a 3A (auto exposure, auto white balance, and auto focus) algorithm, to select a histogram having the best exposure level and to set an exposure level for each image sensor to the exposure level for the selected histogram.

In some embodiments, the plurality of image sensors are arranged in an array. For example, the plurality of image sensors may include an array of red, green, and blue image sensors. An exemplary array of red, green, and blue image sensors may include four red image sensors, eight green image sensors, and four blue image sensors.

In some embodiments, the image signal processor may acquire a frame of image data only from the green image sensors.

According to other embodiments of the present invention, a computer program product includes a non-transitory computer readable storage medium that has encoded thereon instructions that, when executed by an image signal processor of a digital camera, causes the image signal processor to acquire a first frame of image data from a plurality of image sensors, generate a plurality of histograms, wherein each histogram is representative of pixel luminance values for image data from a respective image sensor, select one of the histograms having the best exposure level, and set an exposure level for each image sensor to the exposure level for the selected histogram prior to acquiring a next frame of image data from the image sensors.

In some embodiments, the plurality of image sensors includes a plurality of red, green, and blue image sensors, and the computer readable storage medium has encoded thereon instructions that, when executed by the image signal processor, cause the image signal processor to acquire a frame of image data only from the plurality of green image sensors.

In some embodiments, the computer readable storage medium has encoded thereon instructions that, when executed by the image signal processor, cause the image signal processor to select one of the histograms having the best exposure level for the image and to set an exposure level for each image sensor to the exposure level for the selected histogram using a control algorithm, such as a 3A (auto exposure, auto white balance, and auto focus) algorithm.

Other methods, devices, and/or computer program products according to embodiments of the invention will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

The accompanying drawings, which form a part of the specification, illustrate key embodiments of the present invention. The drawings and description together serve to fully explain the invention.

FIG. 1 is a block diagram illustrating an auto exposure convergence loop for a conventional digital camera.

FIG. 2 illustrates an electronic device in the form of a wireless terminal, such as a cellular phone, that may incorporate a digital camera and image signal processor, according to some embodiments of the present invention.

FIG. 3 illustrates the electronic device of FIG. 2 connected to a cellular network.

FIG. 4 is a block diagram of various components of the electronic device of FIG. 2.

FIG. 5 is a block diagram illustrating a digital camera auto exposure convergence loop, according to some embodiments of the present invention.

FIG. 6 illustrates an exemplary histogram generated from image data.

FIG. 7 is a flowchart of operations for reducing startup time for a digital camera, such as the digital camera in the electronic device of FIG. 2.

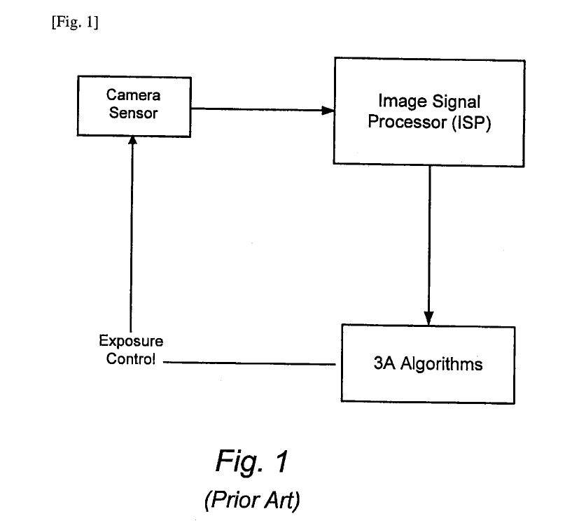

### DETAILED DESCRIPTION

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

As used herein, the term “comprising” or “comprises” is open-ended, and includes one or more stated features, integers, elements, steps, components or functions but does not preclude the presence or addition of one or more other features, integers, elements, steps, components, functions or groups thereof. As used herein, the term “and/or” includes any and all combinations of one or more of the associated listed items. Furthermore, as used herein, the common abbreviation “e.g.”, which derives from the Latin phrase “exempli gratia,” may be used to introduce or specify a general example or examples of a previously mentioned item, and is not intended to be limiting of such item. If used herein, the common abbreviation “i.e.”, which derives from the Latin phrase “id est,” may be used to specify a particular item from a more general recitation.

The terminology used herein is for the purpose of describing particular embodiments only and is not intended to be limiting of the invention. As used herein, the singular forms “a”, “an” and “the” are intended to include the plural forms as well, unless the context clearly indicates otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of this disclosure and the relevant art and will not be interpreted in an idealized or overly formal sense unless expressly so defined herein. It will be understood that when an element is referred to as being “coupled” or “connected” to another element, it can be directly coupled or connected to the other element or intervening elements may also be present. In contrast, when an element is referred to as being “directly coupled” or “directly connected” to another element, there are no intervening elements present. Furthermore, “coupled” or “connected” as used herein may include wirelessly coupled or connected.

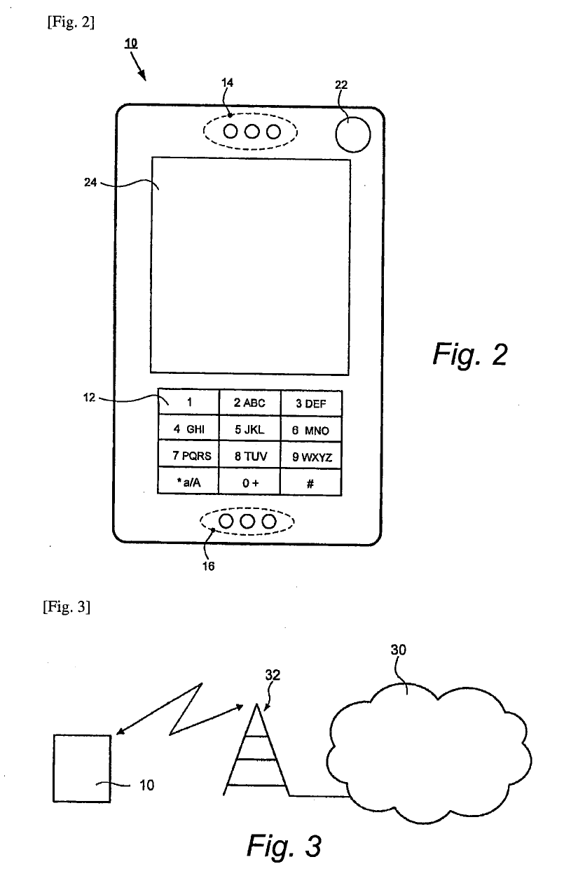

An electronic device 10 that may include a digital camera according to some embodiments of the present invention is shown in FIG. 2. The illustrated electronic device 10 is a wireless terminal, such as a cellular phone, and includes a keypad 12, a speaker 14, and a microphone 16. The keypad 12 is used for entering information, such as selection of functions and responding to prompts. The keypad 12 may be of any suitable kind, including but not limited to keypads with suitable push-buttons, as well as suitable touch-buttons and/or a combination of different suitable button arrangements. The keypad 12 may be a touch screen. The speaker 14 is used for presenting sounds to the user and the microphone 16 is used for sensing the voice from a user. In addition, the illustrated wireless terminal 10 includes an antenna, which is used for communication with other users via a network. However, the antenna may be built into the wireless terminal 10 and is not shown in FIG. 2.

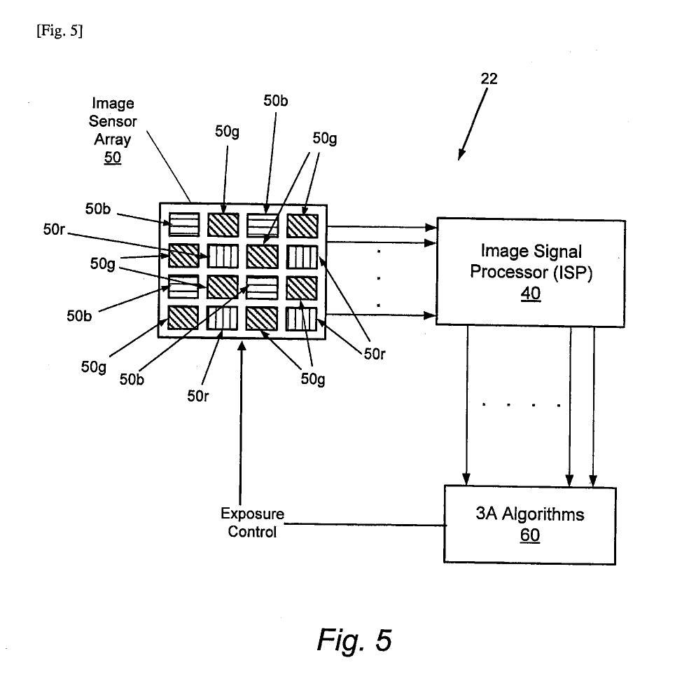

The illustrated wireless terminal 10 includes a digital camera 22 configured to acquire still images and/or moving images (e.g., video). The camera 22 includes a lens (not shown) and a plurality of image sensors (e.g., 50r, 50g, 50b, FIG. 5) that are configured to capture and convert light into electrical signals. By way of example only, the image sensors may include CMOS image sensors (e.g., CMOS active-pixel sensors (APS)) or CCD (charge-coupled device) sensors. Generally, the image sensors in the camera 22 include an integrated circuit having an array of pixels, wherein each pixel includes a photodetector for sensing light. As those skilled in the art will appreciate, the photodetectors in the imaging pixels generally detect the intensity of light captured via the camera lenses.

The image sensors may further include a color filter array (CFA) that may overlay or be disposed over the pixel array of the image sensors to capture color information. The color filter array may include an array of small color filters, each of which may overlap a respective pixel of each image sensor and filter the captured light by wavelength. Thus, when used in conjunction, the color filter array and the photodetectors may provide both wavelength and intensity information with regard to light captured through the camera 22, which may be representative of a captured image.

In addition, the illustrated wireless terminal 10 includes a display 24 for displaying functions and prompts to a user of the wireless terminal 10. The display 24 is also utilized for presenting images recorded by the camera 22. The display 24 is arranged to present images previously recorded as well as images currently recorded by the camera 22. In other words, typically, the display 24 can operate both as a view finder and as presentation device for previously recorded images.

The wireless terminal 10 illustrated in FIG. 2 is just one example of an electronic device in which embodiments of the present invention can be implemented. For example, a camera according to embodiments of the present invention can also be used in a PDA (personal digital assistant), a palm top computer, a tablet device, a lap top computer, or any other portable device. Moreover, embodiments of the present invention may be implemented in standalone cameras, such as portable digital cameras.

FIG. 3 illustrates the wireless terminal 10 connected to a cellular network 30 via a base station 32. The network 30 is typically global system for mobile communication (GSM) or a general packet radio service (GPRS) network, or any other 2G, 2.5G or 2.75G network. The network may be a 3G network, such as a wideband code division multiple access (WCDMA) network. However, the network 30 does not have to be a cellular network, but can be some type of network, such as Internet, a corporate intranet, a local area network (LAN) or a wireless LAN.

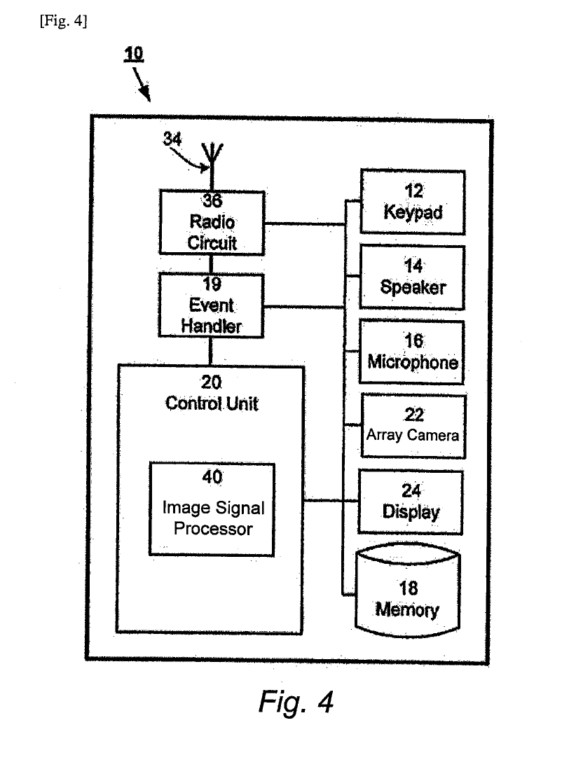

FIG. 4 shows various components of the wireless terminal 10 of FIG. 2 that are relevant to embodiments of the present invention described herein. As previously explained, the illustrated wireless terminal 10 includes keypad 12, a speaker 14, a microphone 16, an array camera 22, and a display 24. In addition, the wireless terminal 10 includes a memory 18 for storing data files, such as image files produced by the camera 22, as well as various programs and/or algorithms for use by the control unit 20 and/or image signal processor 40. The memory 18 may be any suitable memory type used in portable devices.

In addition, the wireless terminal 10 includes an antenna 34 connected to a radio circuit 36 for enabling radio communication with the network 30 in FIG. 3. The radio circuit 36 is in turn connected to an event handler 19 for handling such events as outgoing and incoming communications to and from external units via the network 30, e.g., calls and messages, e.g., SMS (Short Message Service) messages and MMS (Multimedia Messaging Service) messages.

The illustrated wireless terminal 10 is also provided with a control unit 20 for controlling and supervising the operation of the wireless terminal 10. The control unit 20 may be implemented by means of hardware and/or software, and it may be comprised of one or several hardware units and/or software modules, e.g., one or several processor units provided with or having access to the appropriate software and hardware required for the functions required by the wireless terminal 10 and/or by the array camera 22.

As illustrated in FIG. 4, the control unit 20 is connected to the keypad 12, the speaker 14, the microphone 16, the event handler 19, the display 24, the array camera 22, the radio unit 36, and the memory 18. This enables the control unit 20 to control and communicate with these units to, for example, exchange information and instructions with the units.

The control unit 20 is also provided with an image signal processor 40 for processing images recorded by the array camera 22 and for setting an initial exposure level for the camera 22 at startup, according to embodiments of the present invention. Being a part of the control unit 20 implies that the image signal processor 40 may be implemented by means of hardware and/or software, and it may also be comprised of one or several hardware units and/or software modules, e.g., one or several processor units provided with or having access to the software and hardware appropriate for the functions required.

Referring now to FIG. 5, an image sensor array 50 of the array camera 22 is illustrated. The illustrated image sensor array 50 includes red, green, and blue image sensors 50r, 50g, 50b. In the illustrated embodiment, the image sensor array 50 includes four red image sensors 50r, eight green image sensors 50g, and four blue image sensors 50b. However, embodiments of the present invention are not limited to the illustrated number or arrangement of the red, green, and blue image sensors 50r, 50g, 50b. Various numbers and types of image sensors may be utilized in array camera 22, according to embodiments of the present invention.

Upon start up of the array camera 22 (i.e., when a user turns on the array camera 22), the image signal processor 40 acquires a first frame of image data from a plurality of the image sensors in the image sensor array 50. At startup, each image sensor (or a plurality of the image sensors) may be set up with a respective unique or different exposure level for the first frame in order to ensure that different histograms can be generated, as described below. The first frame of image data may be from any number of image sensors. For example, FIG. 5 illustrates an image sensor array having sixteen image sensors. According to some embodiments, the first frame of image data may be acquired from all sixteen image sensors 50r, 50g, 50b. However, in other embodiments, the first frame of image data may be acquired from a subset of the image sensors 50r, 50g, 50b.

For example, in some embodiments, image data is only acquired from the green image sensors 50g. Luminance for a red, green, blue sensor array can be calculated by the formula Y=0.21*R+0.72*G+0.07B. As can be seen, the green channel contributes to 72% of total luminance. As such, the green channel, alone, can give a very good estimate of the luminance of an image captured by a red, green, blue sensor array. Thus, in some embodiments, image data is acquired only from the eight green image sensors 50g by the image signal processor 40.

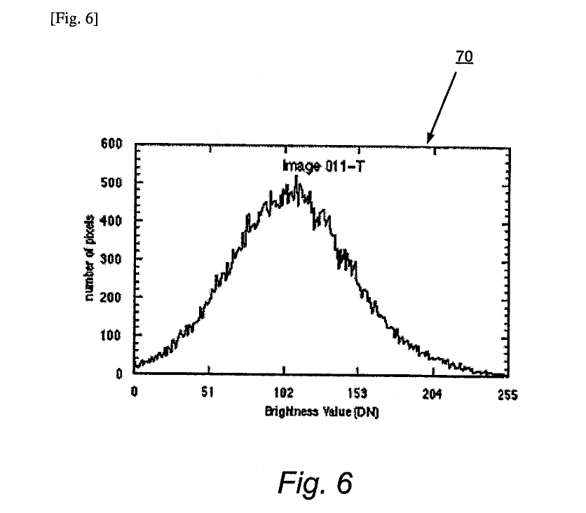

The image signal processor 40 then generates a plurality of histograms. Each histogram is representative of pixel luminance values for image data from a respective image sensor. A histogram is a bar graph that displays the distribution of light, dark and color tonal values of a digital image. For example, FIG. 6 illustrates an exemplary histogram 70. The illustrated histogram 70 displays all the available tonal values of a digital image along the horizontal axis (bottom) of the graph from left (darkest) to right (lightest). The vertical axis represents how much of the image data (i.e., number of pixels) is found at any specific brightness value.

The image signal processor 40 selects the histogram that has the best exposure level for the image data and then sets an exposure level for each image sensor 50r, 50g, 50b to the exposure level for the selected histogram prior to acquiring a next frame of image data from the image sensors 50r, 50g, 50b. In some embodiments, the image signal processor 40 uses a control algorithm, such as a 3A (auto exposure, auto white balance, and auto focus) algorithm 60, to select a histogram having the best exposure level and to set an exposure level for each image sensor to the exposure level for the selected histogram. Thus, when starting up the array camera 22 of the electronic device 10, image data is acquired from the eight green image sensors 50g, each having a different exposure level. Image data from these eight image sensors are fed into the image signal processor 40, which generates eight different histograms. The 3A algorithm 60 then selects the best exposure level of these and then sets up the array camera 22 to give correct exposure on all image sensors of the array camera 22 for the next frame of image data. Because embodiments of the present invention require only a single frame of image data, instead of the typical six to eight frames, the startup time for a digital camera can be decreased significantly. For example, startup time can be reduced to about two hundred milliseconds (200 ms), which is quite noticeable to a user.

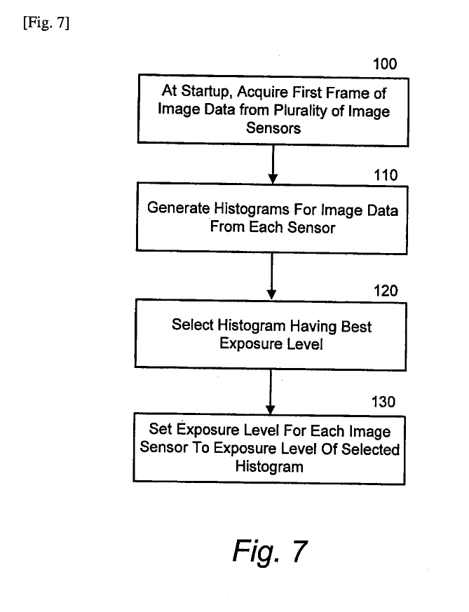

Referring now to FIG. 7, operations performed by an image signal processor (40, FIG. 5) for setting an auto exposure level for a digital camera at startup are illustrated. At startup, a first frame of image data is acquired from a plurality of image sensors of a camera (Block 100). A plurality of histograms are generated (Block 110). Each histogram is generated for the image data from a respective image sensor, and is representative of pixel luminance values for image data from a respective image sensor. The histogram having he best exposure level at camera startup is selected (Block 120). The exposure level for each image sensor is then set to the exposure level for the selected histogram prior to acquiring a next frame of image data from the image sensors (Block 130).

The present invention may be embodied as systems, methods, and/or computer program products. Accordingly, the present invention may be embodied in hardware and/or in software, including firmware, resident software, micro-code, etc. Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: a portable computer diskette, a random access memory (RAM), a read-only memory (ROM), an erasable programmable read-only memory (EPROM or Flash memory), and a portable compact disc read-only memory (CD-ROM).

Computer program code for carrying out operations of data processing systems discussed herein may be written in a high-level programming language, such as Java, AJAX (Asynchronous JavaScript), C, and/or C++, for development convenience. In addition, computer program code for carrying out operations of embodiments of the present invention may also be written in other programming languages, such as, but not limited to, interpreted languages. Some modules or routines may be written in assembly language or even micro-code to enhance performance and/or memory usage. Embodiments of the present invention are not limited to a particular programming language. It will be further appreciated that the functionality of any or all of the program modules may also be implemented using discrete hardware components, one or more application specific integrated circuits (ASICs), or a programmed digital signal processor or microcontroller.

The present invention is described herein with reference to flowchart and/or block diagram illustrations of methods, systems, and computer program products in accordance with exemplary embodiments of the invention. These flowchart and/or block diagrams further illustrate exemplary operations for displaying tag words for selection by users engaged in social tagging of content via a communications network, in accordance with some embodiments of the present invention. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means and/or circuits for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

Many variations and modifications can be made to the preferred embodiments without substantially departing from the principles of the present invention. All such variations and modifications are intended to be included herein within the scope of the present invention, as set forth in the following claims.

1. A method of setting an auto exposure level for a digital camera at startup, wherein the digital camera has a plurality of image sensors, the method comprising:
acquiring a first frame of image data from the plurality of image sensors;
generating a plurality of histograms, wherein each histogram is representative of pixel luminance values for image data from a respective image sensor;
selecting one of the histograms having the best exposure level; and
setting an exposure level for each image sensor to the exposure level for the selected histogram prior to acquiring a next frame of image data from the image sensors.

2. The method of claim 1, wherein the plurality of image sensors are arranged in an array.

3. The method of claim 1, wherein the plurality of image sensors includes a plurality of red, green, and blue image sensors, and wherein acquiring a frame of image data from the plurality of image sensors comprises acquiring a frame of image data only from the plurality of green image sensors.

4. The method of claim 3, wherein the plurality of green image sensors comprises at least eight green image sensors.

5. The method of claim 1, wherein the plurality of image sensors are green image sensors.

6. The method of claim 1, wherein generating the plurality of histograms is performed by an image signal processor.

7. The method of claim 6, wherein selecting one of the histograms having the best exposure level and setting an exposure level for each image sensor to the exposure level for the selected histogram are performed by the image signal processor using a control algorithm.

8. The method of claim 7, wherein the control algorithm is a 3A (auto exposure, auto white balance, and auto focus) algorithm.

9. An electronic device, comprising:
a plurality of image sensors;
an image signal processor;
memory coupled to the image sensor processor and comprising computer readable program code embodied in the memory that, when executed by the image signal processor, causes the image signal processor to perform operations comprising:
acquiring a first frame of image data from the plurality of image sensors;
generating a plurality of histograms, wherein each histogram is representative of pixel luminance values for image data from a respective image sensor;
selecting one of the histograms having the best exposure level; and
setting an exposure level for each image sensor to the exposure level for the selected histogram prior to acquiring a next frame of image data from the image sensors.

10. The electronic device of claim 9, wherein the plurality of image sensors are arranged in an array.

11. The electronic device of claim 9, wherein the plurality of image sensors includes a plurality of red, green, and blue image sensors, and wherein acquiring the first frame of image data from the plurality of image sensors comprises acquiring the first frame of image data only from the plurality of green image sensors.

12. The electronic device of claim 11, wherein the plurality of green image sensors includes at least eight green image sensors.

13. The electronic device of claim 9, wherein the plurality of image sensors are green image sensors.

14. The electronic device of claim 9, wherein selecting one of the histograms having the best exposure level, and setting an exposure level for each image sensor to the exposure level for the selected histogram are performed by the image signal processor using a control algorithm.

15. The electronic device of claim 14, wherein the control algorithm is a 3A (auto exposure, auto white balance, and auto focus) algorithm.

16. The electronic device of claim 9, comprising at least one of a mobile cellular telephone, a portable media player, a tablet computer, a camera, or any combination thereof.

17. A computer program product, comprising a non-transitory computer readable storage medium having encoded thereon instructions that, when executed by a processor, cause the processor to perform operations comprising:
acquiring a first frame of image data from a plurality of image sensors;
generating a plurality of histograms, wherein each histogram is representative of pixel luminance values for image data from a respective image sensor;
selecting one of the histograms having the best exposure level; and
setting an exposure level for each image sensor to the exposure level for the selected histogram prior to acquiring a next frame of image data from the image sensors.

18. The computer program product of claim 16, wherein the plurality of image sensors includes a plurality of red, green, and blue image sensors, and wherein the computer readable storage medium has encoded thereon instructions that, when executed by the processor, cause the processor to acquire a frame of image data only from the plurality of green image sensors.

19. The computer program product of claim 16, wherein the computer readable storage medium has encoded thereon instructions that, when executed by the processor, cause the processor to select one of the histograms having the best exposure level and set an exposure level for each image sensor to the exposure level for the selected histogram using a control algorithm.

20. The computer program product of claim 18, wherein the control algorithm is a 3A (auto exposure, auto white balance, and auto focus) algorithm.
